(19) United States
(12) Patent Application Publication
(10) Pub. No.: US 2009/0097898 A1
(43) Pub. Date: Apr. 16, 2009

(54) HAND HELD PHOTOCHROMIC MARKING IMPLEMENT

(75) Inventors: Gabriel Iftime, Mississauga (CA); Christopher A. Wagner, Toronto (CA); C. Geoffrey Allen, Waterdown (CA); Peter M. Kazmaier, Mississauga (CA); Paul F. Smith, Oakville (CA)

Correspondence Address: MARGER JOHNSON & MCCOLLOM, P.C. - Xerox, 210 SW MORRISON STREET, SUITE 400, PORTLAND, OR, 97204, US

(73) Assignee: Xerox Corporation, Norwalk, CT (US)

(21) Appl. No.: 11/873,213

(22) Filed: Oct. 16, 2007

(51) Int. Cl. B43K 19/00; B29C 39/12

(52) U.S. Cl. 401/49; 264/279.1

(57) ABSTRACT

Disclosed is a hand-held photochromic marking implement including photochromic colorants and a solid phase colorant carrier which can be used in direct-to-media marking and a method of forming same.

### BACKGROUND

In one embodiment, hand held photochromic marking implements and methods for making the same. In another embodiment, hand-held marking implements that can include a handle portion for gripping the marking implement, and that includes a marking portion comprising a solid carrier material and a plurality of photochromic colorants. In a further embodiment a method can be provided for forming a hand-held marking implement. In still a further embodiment, this method can comprise forming flowable solid carrier materials including photochromic colorants and cooling and shaping the flowable carrier material. In this way a solid hand-held marking implement as described above can be formed.

In general, hand-held marking implements can have many structural forms and utilize many direct marking modes. The typical structure of a marking implement is a variation on an elongated, stick-like form, which facilitates controlled marking by the human hand. The common direct marking modes can include deposition of either colored liquid substances, such as an ink, or colored solid phase substances, such as a graphite, chalk, or wax, onto a recording medium. Marking implements comprising a colorant incorporated into a solid carrier of wax or chalk are commonly referred to as crayons. Crayons are in the solid phase at ambient temperature, but are soft enough to deposit colored carrier material directly onto selected media.

Photochromism in general can be a reversible change of a single chemical species, a photochromogen, between two states having distinguishably different absorption spectra, wherein the change is induced in at least one state by the action of electromagnetic radiation. In one embodiment, the inducing radiation, as well as the changes in the absorption spectra, are in the ultraviolet, visible, or infrared regions. In another embodiment, the change in states is thermally induced. The photochromogen can be a molecule or an ion, and the reversible change in states may be a conversion between two molecules or ions, or the dissociation of a single molecule or ion into two or more species, with the reverse change being a recombination of the two or more species thus formed into the original molecule or ion. Photochromic phenomena can occur in both organic compounds, such as anils, disulfoxides, hydrazones, osazones, semicarbazones, stilbene derivatives, o-nitrobenzyl derivatives, spiro compounds, and in inorganic compounds, such as metal oxides, alkaline earth metal sulfides, titanates, mercury compounds, copper compounds, minerals, transition metal compounds such as carbonyls, and the like. Photochromic materials are known in applications such as eyeglasses, toys, clothing, and inks. Photochromic phase change ink compositions are described in U.S. Pat. Nos. 5,593,486 and 5,759,729, which are incorporated herein in their entirety by reference.

A need remains for improved hand-held direct marking implements which, unlike conventional marking implements, have photochromic characteristics. These characteristics can provide, for example, the ability to create marks that either become visible or change color state upon activation. A need further remains for marking implements having compositions and structural shapes designed to be hand-held and capable of directly marking various recording media with a mark having a modifiable visual appearance. There is an artistic need for a hand-held, direct-to-media marking implement that can create a mark that can be reversibly modulated between a first color and a second color. There is also a need for a simple, hand-held direct-to-media marking implement which enables the quick placement of a marking on a medium which is detectable during immediate application to the medium, and is not readily detectable after immediate application until it is activated by a radiation source.

### SUMMARY

In an embodiment herein hand held photochromic marking implements and methods for making the same are provided. In a further embodiment, a hand-held marking implement can be provided that includes a handle portion for gripping the marking implement, and a marking portion comprising a solid carrier material and a plurality of photochromic colorants. In another embodiment described herein an inner marking portion comprising a solid phase carrier material and a first photochromic colorant, and an outer marking portion comprising a solid phase carrier material and a second photochromic colorant. The outer marking portion surrounds the inner marking portion so that the inner marking portion is not contacted by external visible light prior to use as a marking implement. A still further embodiment can be provided comprising a method for forming a hand-held marking implement. This method can be as described above.

### DETAILED DESCRIPTION

The marking implement as disclosed herein has a handle portion and at least one marking portion. The marking portion may be a point, an edge, or a surface that can be used to write or mark on a recording medium. In one embodiment, the marking implement has a generally elongated, stick-like handle portion that can be comfortably grasped by the hand of a user and the marking portion has a tapered shape adapted for marking. At least the marking portion of this embodiment comprises a solid phase carrier material and a plurality of photochromic colorants. Depending on the specific embodiment, the handle portion may also comprise the solid carrier material and the plurality photochromic colorant. In a particular embodiment, the handle portion of the marking implement is comprised primarily of the carrier material and thus the physical properties of the both the handle portion and the marking portion depend directly on the physical properties of the carrier material. In another embodiment, the handle portion of the marking implement comprises the carrier material embedded within an outer cladding, wherein the physical properties of the marking implement handle portion depends only indirectly on the physical properties of the carrier material. In still other embodiments, the handle portion of the marking implement does not comprise any of the carrier material and only the marking portion contains the carrier material and photochromic colorants.

In one embodiment, the solid phase carrier comprises a low polarity wax to control the melting point, softness, and basic physical properties of the carrier material. These mechanical factors can influence the durability and marking or writing performance of the solid phase carrier, such as resistance to breakage and bending of the marking portion of the implement, pressure needed to mark a recording medium, smoothness of marking, adhesion of marking, and minimization of crumbling and other undesired phenomena when marking. As the melting point of the low polarity wax is reduced, the wax becomes mechanically softer. Thus, the hardness of the carrier material can be tailored by first choosing a wax of a particular melting or softening point and then choosing the percent composition of the particular wax in the carrier material. In embodiments of the present invention, the low polarity wax can be paraffins, microcrystalline waxes, polyethylene waxes, ester waxes, amide waxes, such as a tetra-amide wax, fatty acids, fatty alcohols, such as the UNILIN® products available from Baker Petrolite, fatty amides and other waxy materials, sulfonamide materials, resinous materials made from different natural sources (such as, for example, tall oil rosins and rosin esters), and many synthetic resins, oligomers, polymers and copolymers, such as ethylene/vinyl acetate copolymers, ethylene/acrylic acid copolymers, ethylene/vinyl acetate/acrylic acid copolymers, copolymers of acrylic acid with polyamides, and the like, ionomers, and the like, as well as mixtures thereof. In particular embodiments of the present invention, the low polarity wax can be Polyethylene Wax 5300 or Polyethylene Wax 8400, both made by Mitsui Chemical. In still other particular embodiments of the present invention, a polyalkylene wax, such as a polyethylene wax, a polypropylene wax, or mixtures thereof. Examples of suitable polyalkylene waxes include POLYWAX® 400 and POLYWAX® 500 (commercially available from Baker Petrolite), Vybar 103 and 253, commercially available from Baker Petrolite, POLYWAX® 655 and higher molecular weight polywax materials are also suitable. In other particular embodiments of the present invention, the low polarity wax is a fatty amide-containing material such as a tetra-amide wax compound. In further embodiments, the tetra-amide wax compounds for producing the phase change ink carrier composition can be Dimer acid-based tetra-amides which include the reaction product of a fatty acid, a diamine (ethylene diamine) and a Dimer acid. Fatty acids having from 10 to 22 carbon atoms can be employed in the formation of the Dimer acid-based tetra-amide. Dimer acid-based tetra-amides can be those produced by Union Camp and can comprise the reaction product of ethylene diamine, Dimer acid, and the following fatty acids: decanoic acid (Union Camp X3202-23), myristic acid (Union Camp X3202-56), stearic acid (Union Camp X3138-43, X3164-23, X3202-44, X3202-46, X3222-65, X3261-37, X3261-53, and X3290-72), docasanic acid (Union Camp X3202-36). In still further embodiments, the Dimer acid-based tetraamide can be the reaction product of Dimer acid, ethylene diamine and stearic acid in a stoichiometric ratio of 1:2:2. Stearic acid can be the fatty acid reactant because its adduct with Dimer acid and ethylene diamine forms low viscosity Dimer acid-based tetra-amides. Its ingredients also are readily available and therefore low in cost. In one such embodiment, the Dimer acid-based tetra-amide material is Unirez resin, made by Union Camp Corporation. Dimer acid-based tetra-amides can be prepared as disclosed in, for example, U.S. Pat. No. 6,174,937, the disclosure of which is totally incorporated herein by reference.

Depending on the desired mechanical properties and the low polarity wax chosen for a particular embodiment, the low polarity wax(es) can be present in the carrier material in one embodiment of at least about 20 percent by weight, in another embodiment of at least about 25 percent by weight, and in yet another embodiment of at least about 30 percent by weight, and in one embodiment equal to or less than about 50 percent by weight, in another embodiment equal to or less than about 55 percent by weight of the ink carrier, and in yet another embodiment equal to or less than about 60 percent by weight of the ink carrier, although the amount can be outside of these ranges.

In certain embodiments, the solid phase carrier material includes a mechanical strengthening agent, thereby lowering the percent composition of low polarity wax in the carrier material. In particular embodiments, a tackifier resin is the mechanical strengthening. In certain embodiments, tackifiers, such as FORAL® 85, a glycerol ester of hydrogenated abietic (rosin) acid (commercially available from Hercules), FORAL® 105, a pentaerythritol ester of hydroabietic (rosin) acid (commercially available from Hercules), CELLOLYN® 21, a hydroabietic (rosin) alcohol ester of phthalic acid (commercially available from Hercules), ARAKAWA KE-311 and KE-100 Resins, triglycerides of hydrogenated abietic (rosin) acid (commercially available from Arakawa Chemical Industries, Ltd.), synthetic polyterpene resins such as NEVTAC® 2300, NEVTAC® 100, and NEVTAC® 80 (commercially available from Neville Chemical Company), WINGTACK® 86, a modified synthetic polyterpene resin (commercially available from Goodyear), and the like, can be utilized.

In certain embodiments, the mechanical strengthening agent is a polyurethane resin. Suitable materials also can include isocyanate-derived resins and waxes, such as urethane isocyanate-derived materials, urea isocyanate-derived materials, urethane/urea isocyanate-derived materials, mixtures thereof, and the like. Further information on isocyanate-derived carrier materials is disclosed in, for example, U.S. Pat. No. 5,750,604, U.S. Pat. No. 5,780,528, U.S. Pat. No. 5,782,966, U.S. Pat. No. 5,783,658, U.S. Pat. No. 5,827,918, U.S. Pat. No. 5,830,942, U.S. Pat. No. 5,919,839, U.S. Pat. No. 6,255,432, U.S. Pat. No. 6,309,453, British Patent GB 2 294 939, British Patent GB 2 305 928, British Patent GB 2 305 670, British Patent GB 2 290 793, PCT Publication WO 94/14902, PCT Publication WO 97/12003, PCT Publication WO 97/13816, PCT Publication WO 96/14364, PCT Publication WO 97/33943, and PCT Publication WO 95/04760, the disclosures of each of which are incorporated herein in their entirety by reference.

In one embodiment, the tackifier can be present in the carrier material in one embodiment of at least about 10 percent by weight, in another embodiment of at least about 15 percent by weight, and in yet another embodiment of at least about 20 percent by weight, and in one embodiment equal to or less than about 40 percent by weight, in another embodiment equal to or less than about 45 percent by weight of the ink carrier, and in yet another embodiment equal to or less than about 50 percent by weight of the ink carrier, although the amount can be outside of these ranges.

In certain embodiments of the present invention, the carrier material includes a dye solubility agent to enhance the solubility of the colorants in the carrier material. In further embodiments suitable dye solubility agents can comprise fatty amides, such as mono-amides, tetra-amides, mixtures thereof, and the like. Specific examples of suitable fatty amide ink carrier materials include stearyl stearamide, a dimer acid based tetra-amide that is the reaction product of dimer acid, ethylene diamine, and stearic acid, a dimer acid based tetra-amide that is the reaction product of dimer acid, ethylene diamine, and a carboxylic acid having at least about 36 carbon atoms, and the like, as well as mixtures thereof. When the fatty amide ink carrier is a dimer acid based tetra-amide that is the reaction product of dimer acid, ethylene diamine, and a carboxylic acid having at least about 36 carbon atoms, the carboxylic acid is of the general formula

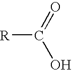

wherein R is an alkyl group, including linear, branched, saturated, unsaturated, and cyclic alkyl groups, said alkyl group in one embodiment having at least about 36 carbon atoms, in another embodiment having at least about 40 carbon atoms, said alkyl group in one embodiment having no more than about 200 carbon atoms, in another embodiment having no more than about 150 carbon atoms, and in yet another embodiment having no more than about 100 carbon atoms, although the number of carbon atoms can be outside of these ranges. Carboxylic acids of this formula are commercially available from, for example, Baker Petrolite, Tulsa, Okla., and can also be prepared as described in Example 1 of U.S. Pat. No. 6,174,937, the disclosure of which is totally incorporated herein by reference. Further information on fatty amide carrier materials is disclosed in, for example, U.S. Pat. No. 4,889,560, U.S. Pat. No. 4,889,761, U.S. Pat. No. 5,194,638, U.S. Pat. No. 4,830,671, U.S. Pat. No. 6,174,937, U.S. Pat. No. 5,372,852, U.S. Pat. No. 5,597,856, U.S. Pat. No. 6,174,937, and British Patent GB 2 238 792, the disclosures of each of which are totally incorporated herein by reference.

The fatty amide solubility agent can be present in the carrier material in one embodiment at least about 30 percent by weight, in another embodiment at least about 40 percent by weight, and in yet another embodiment at least about 50 percent by weight, and in one embodiment equal to or less than about 70 percent by weight, in another embodiment equal to or less than about 80 percent by weight of the ink carrier, and in yet another embodiment equal to or less than about 90 percent by weight of the ink carrier, although the amount can be outside of these ranges.

Embodiments of the present invention incorporate a variety of photochromic colorants with a variety of carrier materials. As used herein, “photochromic” is intended to describe changes in color or changes from colorless to colored or from colorless to colored upon activation. “Photochromic” is not intended to include a colorant which has a first color when exposed to a first segment of the visible light spectrum and a second color appearance upon exposure to a second segment of the visible light spectrum.

In an embodiment the change from colored to colorless will occur upon exposure to visible light. Activation of the photochromic colorant from colorless to a predetermined color can be achieved in one embodiment by exposure to electromagnetic radiation. In another embodiment the photochromic colorant is activated by electromagnetic radiation having an ultraviolet wavelength. This latter activation can be accomplished in the wavelength or energy range commonly consider within the ultraviolet spectrum. Examples of such ultraviolet absorbing dyes are disclosed in, for example, U.S. Pat. No. 5,378,574, U.S. Pat. No. 5,146,087, U.S. Pat. No. 5,145,518, U.S. Pat. No. 5,543,177, U.S. Pat. No. 5,225,900, U.S. Pat. No. 5,301,044, U.S. Pat. No. 5,286,286, U.S. Pat. No. 5,275,647, U.S. Pat. No. 5,208,630, U.S. Pat. No. 5,202,265, U.S. Pat. No. 5,271,764, U.S. Pat. No. 5,256,193, U.S. Pat. No. 5,385,803, and U.S. Pat. No. 5,554,480, the disclosures of each of which are incorporated herein in their entirety by reference.

In particular it has been found in embodiments herein that when writing with the marking implement containing photochromic additive in the colorless state, the writing is extremely difficult to perform accurately since the scribe cannot see the letters as they are being traced. In a further embodiment two different classes of photochromic compounds are employed together in the respective outer and inner portions thereof.

A first photochromic compound, which ultimately becomes colored by UV light, is thermally stable but becomes colorless on exposure to visible room light. The second photochromic compound, which becomes colored by UV illumination, fades at room temperature. In another embodiment, the second photochromic compound can fade by a thermal mechanism.

In an embodiment which employs this first and second photochromic compound formulation, the marking implement contains at the same time a first photochromic compound in the colored state and a second photochromic compound in the colorless state (since it reverts thermally on storage it will always be in the colorless state anyway). In one embodiment, the first photochromic compound is located in the inner marking portion on the interior of the marketing implement and is surrounded by an outer portion. Therefore, it is not exposed to light prior to use. Thus, it remains colored until written on a substrate when the room light decolorizes it. This embodiment of the marking implement enables the writer to see the text as it is being written as faint characters which quickly decolorize. The hidden text can then be viewed when activated as described above. In one embodiment this can be accomplished using a black light. The bulk of the fading with respect to the marking implement occurs thermally and, since the second photochromic compound typically undergoes fading thermally, the fading rate can be controlled by the choice of the second photochromic compound.

In an embodiment herein, a hand held marking implement comprising a handle portion for gripping said marking implement, an inner marking portion comprising a solid phase carrier material and a first photochromic colorant, and an outer marking portion comprising a solid phase carrier material and a second photochromic colorant. The outer marking portion surrounds the inner marking portion so that said inner marking portion is not contacted by external visible light prior to use as a marking implement. In a further embodiment, the first photochromic colorant is substantially colored when not exposed to visible light, and thermally stable but becomes substantially colorless when exposed to visible light such as room visible light. In another embodiment, after the first photochromic colorant is in a substantially colorless state, having been exposed to visible light, it can be activated to form a predetermined color. In a still another embodiment, this activation can be accomplished as described above employing electromagnetic radiation, and in still a further embodiment, the electromagnetic radiation can have an ultraviolet wavelength.

In one embodiment, the first photochromic colorants can comprise dithienyl ethane compounds, fulgide compounds, or combinations thereof.

In another embodiment, the second photochromic colorants can comprise a spiropyran compound, a spironaphthoxazine compound, a chromene compound, a dihydroindolizine compound, a quinone compound, a perimidinespirocyclohexadienone compound, a bisimidazole compound, a bis-tetraphenylpyrrole compound, a hydrazine compound, an aryl disulfide compound, a stilbene compound, an aromatic azo compound, and mixtures thereof. In yet another embodiment, the spiropyran compound comprises 1′3′-Dihydro-1′,3′,3′-trimethyl-6-nitrospiro[2H-1-benzopyran-2,2′-(2H)-indole], the spironaphthoxazine compound comprises 1,3-dihydro-1,3,3-trimethylspiro[2H-indole-2,3′-[3H]naphtha[2,1-b][1,4]oxazine, and the chromene compound comprises a benzopyran or a naphthopyran.

In a further embodiment herein, the second photochromic colorants can include compounds that undergo heterolytic cleavage, such as spiropyrans, benzospiropyrans, related compounds, and the like; compounds that undergo homolytic cleavage, such as bis-imidazole compounds, bis-tetraphenylpyrrole, hydrazine compounds, aryl disulfide compounds, and the like; compounds that undergo cis-trans isomerization, such as stilbene compounds, photoisomerizable azo compounds, and the like; compounds that undergo photochromic tautomerism, including those that undergo hydrogen transfer phototautomerism, those that undergo photochromic valence tautomerism, and the like; including those disclosed in U.S. Pat. No. 5,759,729, the disclosure of which is incorporated herein in its entirety by reference. As an illustrative example, a photochromic spirobenzopyran can be formed by combining an indoline derivative with 5-nitrosalicylaldehyde.

Various colors can be obtained through the use of different photochromic colorants. When dithienyl ethenes are use as the first photochromic colorants they are generally transformed from a colorless state to green or blue. When spiropyrans are used as the second photochromic colorants they are generally transformed from a colorless state to a deep purple or magenta. For example, 1′3′-Dihydro-1′,3′,3′-trimethyl-6-nitrospiro-[2H-1-benzopyran-2,2′-(2H)-indole], available from Aldrich Chemical Co., Milwaukee, Wis., having the structure:

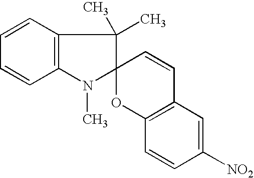

develops to a purple-black color upon exposure to ultraviolet light. Another exemplary photochromic material is 1′-Dodecyl-6-nitro BIPS, where BIPS is Spiro (2H-1-benzopyran-2,2′-indoline, available from Chroma Chemicals, Dayton, Ohio. Yet another exemplary photochromic material is 1,3-dihydro-1,3,3-trimethylspiro[2H-indole-2,3′-[3H]naphtha[2,1-b]-[1,4]oxazine, available from Aldrich Chemical Company, Milwaukee, Wis.

The photochromic colorant is present in the solid phase carrier in any desired or effective amount to obtain the desired color or hue. In one embodiment of the present invention, the quantity of colorant is about 0.1 percent by weight of the carrier material. In a further embodiment, the colorant is about 0.5 percent by weight of the carrier material, and in another embodiment about 1 percent by weight of the ink. In yet another embodiment, the amount colorant is no more than about 5 percent by weight of the carrier material, and in still another embodiment the colorant forms no more than about 10 percent by weight the of the carrier material.

Specific hand held marking implement embodiments will now be described in detail. These examples are intended to be illustrative, and the claims are not limited to the materials, conditions, or process parameters set forth in these particular embodiments.

### EXAMPLE

The inner marking portion of the marking implement is fabricated as follows:

5 g of 1,2-bis(2-methyl-5-phenyl-3-thienyl)perfluorocyclopentene, a photochromic compound of the first type, i.e. becomes colored by UV light and is thermally stable but becomes colorless on exposure to visible light room, is dissolved in 100 ml of acetone, and stirred under exposure to UV light source (in a UV reactor available from Ace Glass) for 3 hours. The solution becomes dark blue, as a result of the colorization of the initially colorless photochromic compound. Further handling of the colored material is performed as much as possible in the absence of visible light in order to prevent premature decolorization. The compound is precipitated out of the solution by addition of hexane (poor solvent) and isolated after filtration as a dark blue powder.

The colored photochromic powder is dissolved in 495 g of Polywax 2000 (melting temperature of about 125° C.) by heating at a temperature of 140° C.). Sufficient amount of the melt is poured into a mould in the shape of a pencil of a diameter of about 3 mm. After pouring, the mould containing the melt is allowed to cool slowly at room temperature, when it solidifies. Removal of the mould provides the inner marking portion.

The outer marking portion of the marking implement was fabricated as follows:

6 g of 1′3′-Dihydro-1′,3′,3′-trimethyl-6-nitrospiro-[2H-1-benzopyran-2,2′-(2H)-indole], a photochromic compound of the second type, i.e. becomes colored by UV light and it fades at room temperature, is dissolved in 194 g of polywax 500 (melting temperature of 86° C.) by heating at 110° C.).

In a second mold in the shape of a pencil of a diameter of about 6 mm, the inner marking portion is placed in such a way that it sits in the middle, and the second melt is poured, such as to cover completely the inner marking portion. Because the temperature of the second photochromic composition is lower, the inner portion does not melt at this stage. In other words, the inner portion is not damaged during the fabrication of the outer portion of the marking implement. After pouring, the mould containing the melt is allowed to cool slowly at room temperature, when it solidifies. Removal of the mould provides the photochromic marking implement.

The marking implements of the present invention are used to directly mark on paper recording media by hand. The marks made are visible to the human eye immediately after writing (blue, i.e. the color of the inner portion), even under ambient light. This allows the user to see the marks or text as they are being written. After longer exposure to ambient room light (for example 5 minutes), the blue coloration disappears due to visible light activation. The marks are invisible. When exposed to a portion of the natural light which is comprised of ultraviolet electromagnetic radiation, the ultraviolet light interacts with both the first and second photochromic compounds. The ultraviolet light activates the photochromic colorants in the marking and the mark becomes visible. The visible marks appear to have a color which is a combination of both colored states of the photochromic materials. Upon subsequent removal of the sample from the ultraviolet radiation source, the mark returns to the deactivated state, wherein the mark is again not visible to the human eye. The marking can “disappear” and “reappear” a multitude of time upon addition or removal of radiation source.

While the embodiments disclosed herein are particular modes of the present invention, it should be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A hand held marking implement comprising:
a handle portion for gripping said marking implement;
an inner marking portion comprising a solid phase carrier material and a first photochromic colorant; and
an outer marking portion comprising a solid phase carrier material and a second photochromic colorant, said outer marking portion surrounding said inner marking portion so that said inner marking portion is not contacted by external visible light prior to use as a marking implement.

2. The marking implement of claim 1, wherein the second photochromic colorant is substantially colorless when inactivated and a predetermined color when activated.

3. The marking implement of claim 1, wherein said first photochromic colorant is substantially colored when inactivated and substantially colorless when exposed to visible light.

4. The marking implement of claim 1, wherein said first and second photochromic colorants are activated by electromagnetic radiation

5. The marking implement of claim 4, wherein said electromagnetic radiation has an ultraviolet wavelength.

6. The marking implement of claim 1, wherein the first photochromic colorant comprises at least one of a dithienylethene compound, a fulgide compound, and mixtures thereof.

7. The marking implement of claim 1, wherein the second photochromic colorant comprises at least one of a spiropyran compound, a spironaphthoxazine compound, a chromene compound, a dihydroindolizine compound, a quinone compound, a perimidinespirocyclohexadienone compound, a bisimidazole compound, a bis-tetraphenylpyrrole compound, a hydrazine compound, an aryl disulfide compound, a stilbene compound, a photoisomerizable azo compound, and mixtures thereof.

8. The marking implement of claim 7, wherein the second photochromic colorant wherein said spiropyran compound comprises 1′3′-Dihydro-1′,3′,3′-trimethyl-6-nitrospiro[2H-1-benzopyran-2,2′-(2H)-indole], said spironaphthoxazine compound comprises 1,3-dihydro-1,3,3-trimethylspiro[2H-indole-2,3′-[3H]naphtha[2,1-b][1,4]oxazine, and said chromene compound comprises a benzopyran or a naphthopyran.

9. The marking implement of claim 1, wherein the carrier material includes a mechanical strengthening agent.

10. The marking implement of claim 10, wherein the mechanical strengthening agent comprises a resin tackifier.

11. The marking implement of claim 1, wherein the solid phase carrier material comprises at least one low polarity wax.

12. The marking implement of claim 11, wherein the low polarity wax comprises a polyethylene wax.

13. The marking implement of claim 11, wherein the low polarity wax comprises a tetra-amide wax.

14. The marking implement of claim 1, wherein the solid phase carrier material further includes a dye solubility agent.

15. The marking implement of claim 14, wherein the dye solubility agent is a fatty amide.

16. The marking implement of claim 1, wherein said handle portion is embedded within an outer cladding.

17. A method of forming a hand-held marking implement comprising:
forming a first flowable solid carrier material including a first photochromic colorant;
forming a second flowable solid carrier material including a second photochromic colorant;
cooling and shaping said first flowable carrier material;
surrounding said cooled and shaped first flowable carrier material with said second flowable solid carrier material;
cooling and shaping said second flowable carrier material; and
forming a solid hand-held marking implement comprising a handle portion for gripping said marking implement and a marking portion comprising said first and second solid carrier materials and said first and second photochromic colorants, respectively.

18. The method of claim 18, further comprising shaping said solid hand-held marking implement by cooling said first and second flowable carrier materials in a mold.

19. The method of claim 19, further comprising wrapping said handle portion with an outer cladding.

20. The method of claim 19, wherein the second photochromic colorant is substantially colorless when inactivated and a predetermined color when activated.

21. The method of claim 19, wherein said first photochromic colorant is substantially colored when inactivated and substantially colorless when exposed to visible light.

22. A hand held marking implement comprising:
a handle portion for gripping said marking implement; and
at least one marking portion comprising a solid phase carrier material and a first and second photochromic colorant, wherein said first photochromic colorant is substantially colored when inactivated or when activated by electromagnetic radiation, and substantially colorless when exposed to visible light, and the second photochromic colorant is substantially colorless when inactivated, and a predetermined color when activated by electromagnetic radiation.
